(19) United States
(12) Patent Application Publication
(10) Pub. No.: US 2008/0083087 A1
(43) Pub. Date: Apr. 10, 2008

(54) Glass door hinge structure

(75) Inventor: Ching-Yi Lin, Changhua Hsien (TW)

Correspondence Address: RABIN & Berdo, PC, 1101 14TH STREET, NW, SUITE 500, WASHINGTON, DC, 20005, US

(73) Assignee: Lin Kun Ta Industrial Co., Ltd., Changhua Hsien (TW)

(21) Appl. No.: 11/543,934

(22) Filed: Oct. 6, 2006

(51) Int. Cl. E05D 5/02

(52) U.S. Cl. 16/252

(57) ABSTRACT

A glass door hinge structure includes a hinge base, an axial bolt, and a fixing base, and a glass door is installed into a clamping groove at the middle of a hinge base and the glass door is free of gaps for a direct installation, and the fixing base is fixed on the ground, and long screw thread holes disposed adjacent to a hole base of the fixing base are provided for turning two long screw bolts, so as to adjust and change the angle for leveling both sides of the glass door and enhance the screw connection and application of the long screw bolts. The resilience of a long spring coil installed to both sides of a transversal screw hole of the hinge base is enhanced to extend the life expectancy and resume the two glass doors quickly to their closed position.

### BACKGROUND OF THE INVENTION

1. Field of the Invention

The present invention relates to a glass door hinge structure, and more particularly to a glass door hinge structure that is installed in a clamping groove at the middle of a hinge base, and a fixing base is fixed onto the ground, so as to achieve the effects of providing a direct and convenient installation of a glass door hinge, adjusting the angle and evenness of both edges of a glass door, preventing a long screw bolt from being damaged, and resuming the glass door quickly to its closed position.

2. Description of the Related Art

Referring to FIGS. 1A and 1B for a common traditional glass door hinge structure, the structure includes a hinge body A, a hinge cover B, an axial bolt C and a fixing base D. A protrusion A1 is disposed on the hinge body A and attached to an internal surface of the hinge cover B, and a distal surface of the protrusion A1 has a through hole A2 with transversal screw threads for installing and combining a bushing A3, a spring coil A4 and a rotating screw bolt A5. A vertical internal hole is disposed at the center of the through hole A2 for installing an axial bolt C, such that sunken grooves C1 disposed on both upper sides of the axial bolt C for propping against the bushing A3, and the bottom of the axial bolt C is situated at a hole base D1 of the fixing base D that is fixed to the ground, and then a screw bolt E is screwed into a screw hole D2 of the hole base D1 to contact and fix the axial bolt C. Since the hinge body A has a protrusion A1, therefore the glass door F must cut a gap F1 (as shown in FIG. 1B) with a size corresponding to the protrusion A1 of the hinge body A in order to successfully install of the glass door F at a position between the hinge body A and the hinge cover B, and then the fixing base D is fixed to the ground. However, it is not an easy job to cut a gap F1 on the thick glass door F, and such cutting operation may damage or ruin the whole door, which will increase the cost significantly. Furthermore, the two installed glass doors F are not always even, and sometimes they may be deviated inward or outward with a slight angle. The prior art cannot linearly align both edges of the glass door F. In addition, a spring coil A4 is installed in the transversal through transversal through hole A2 of the hinge body A, and its length is too short, and thus the glass door F resumes its closed position very slowly and the glass door F just looks like it cannot be closed at all.

### SUMMARY OF THE INVENTION

In view of the foregoing shortcomings of the present invention, the inventor of the present invention based on years of experience on the related field to conduct extensive experiments and modifications and finally developed a glass door hinge structure in accordance with the present invention.

Therefore, it is a primary objective of the present invention to overcome the shortcomings of the prior art by providing a glass door hinge structure that comprises a hinge base, an axial bolt, and a fixing base. The hinge base has a clamping groove at its middle and one of the surfaces is a thickened surface, and the thickened surface has a transversal screw hole for installing and combining a protruding bolt, a long spring coil and a rotating screw bolt. The screw hole has a vertical internal hole at its center for installing an axial bolt and a sunken groove disposed on both upper sides of the axial bolt for propping the protruding bolt by the resilience of the long spring coil, and the bottom of the axial bolt is situated in a center hole of the hole base of the fixing base, and two long screw bolts are screwed into a long screw thread hole of the hole base of the fixing base and touched with the two sunken surfaces on both left and right sides of the axial bolt. After the glass door is installed in a clamping groove at the middle of the hinge base and the fixing base is fixed onto the ground, two long screw bolts on the fixing base are turned to adjust and change the angle for leveling both edges of the glass door, and the invention can enhance the screw connection and application of the long screw bolt and prevent it from being damaged easily.

Another objective of the present invention is to provide a glass door hinge structure, wherein a glass door is installed at a position of a clamping groove in the hinge base, and the glass door is free of gaps and provided for a direct installation, so as to overcome the problems and difficulties of cutting a gap on a traditional glass door, damaging or ruining the glass door, or increasing the cost.

A further objective of the present invention is to provide a glass door hinge structure, wherein the resilience of the long spring coil installed on both sides of the transversal screw hole in a thickened surface of the hinge base is enhanced to extend the life expectancy and resume the two glass doors quickly to their closed position.

### BRIEF DESCRIPTION OF THE DRAWINGS

FIG. 1A is a schematic view of an installing position of a prior art;

FIG. 1B is an exploded view of a prior art;

FIG. 2 is a schematic view of an installing position of the present invention;

FIG. 3A is an exploded view of a structure of the present invention;

FIG. 3B is another exploded view of a structure of the present invention;

FIG. 3C is a further exploded view of a structure of the present invention;

FIG. 4A is a perspective of the present invention;

FIG. 4B is another perspective of the present invention;

FIG. 5 is a schematic view of an assembled structure of the present invention; and

FIG. 6 is another schematic view of an assembled structure of the present invention.

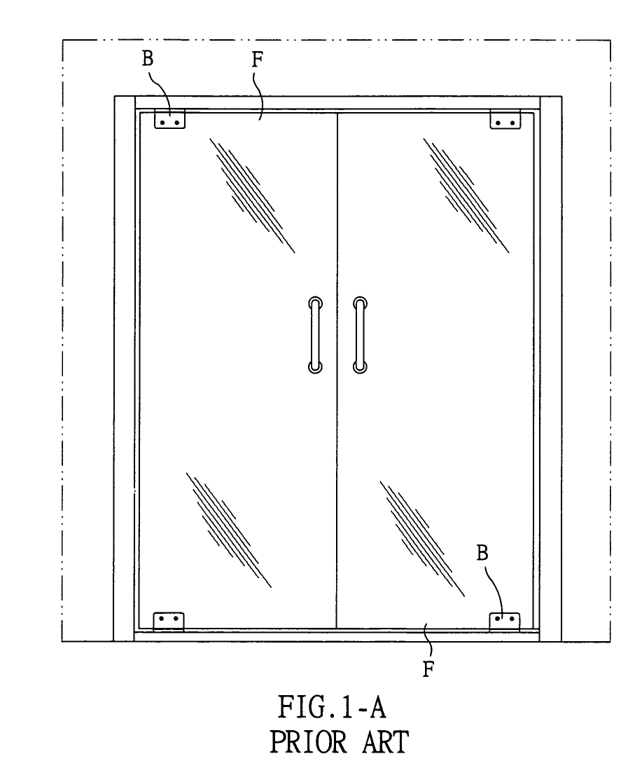

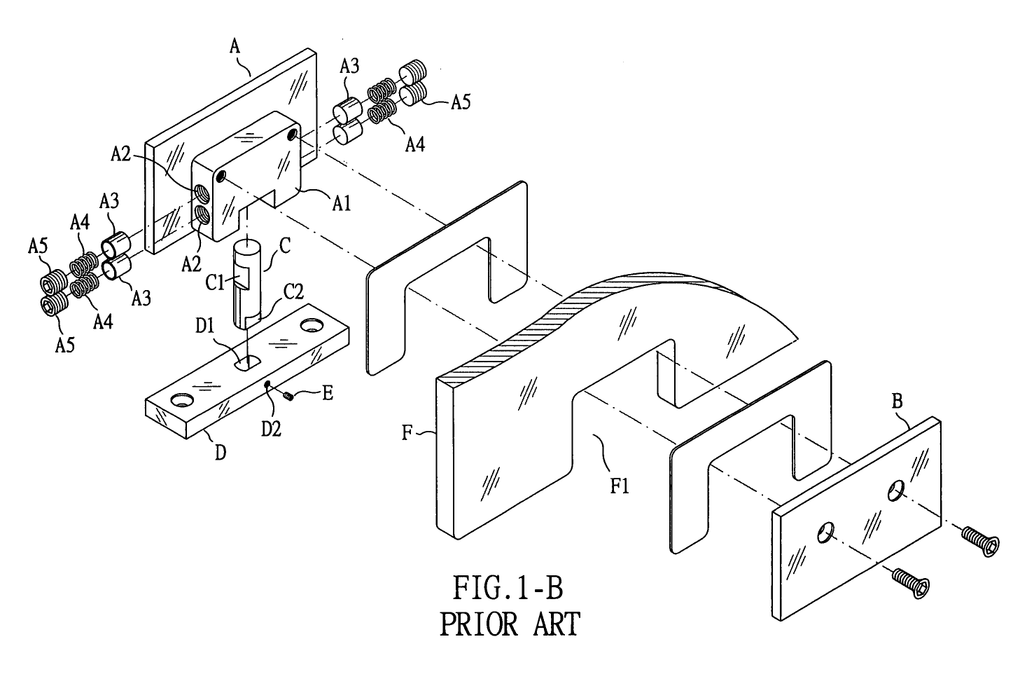

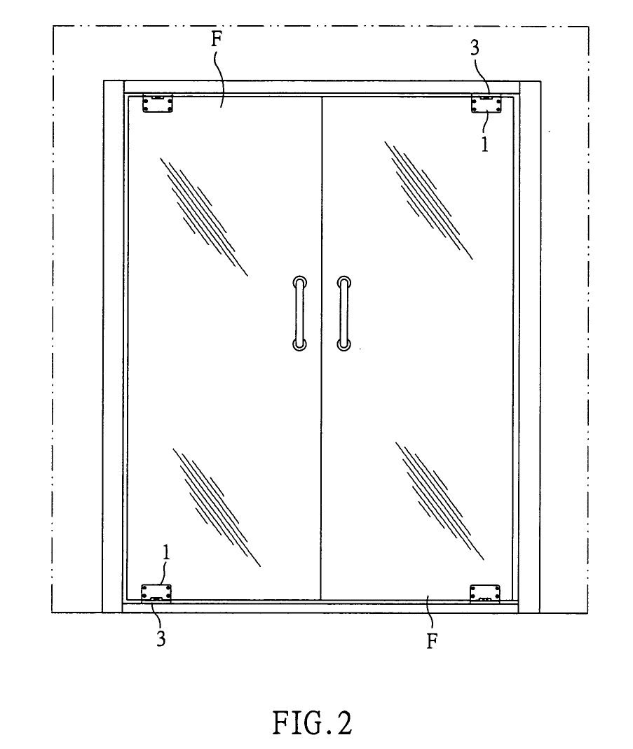

### DETAILED DESCRIPTION OF THE PREFERRED EMBODIMENTS

The above and other objects, features and advantages of the present invention will become apparent from the following detailed description taken with the accompanying drawing.

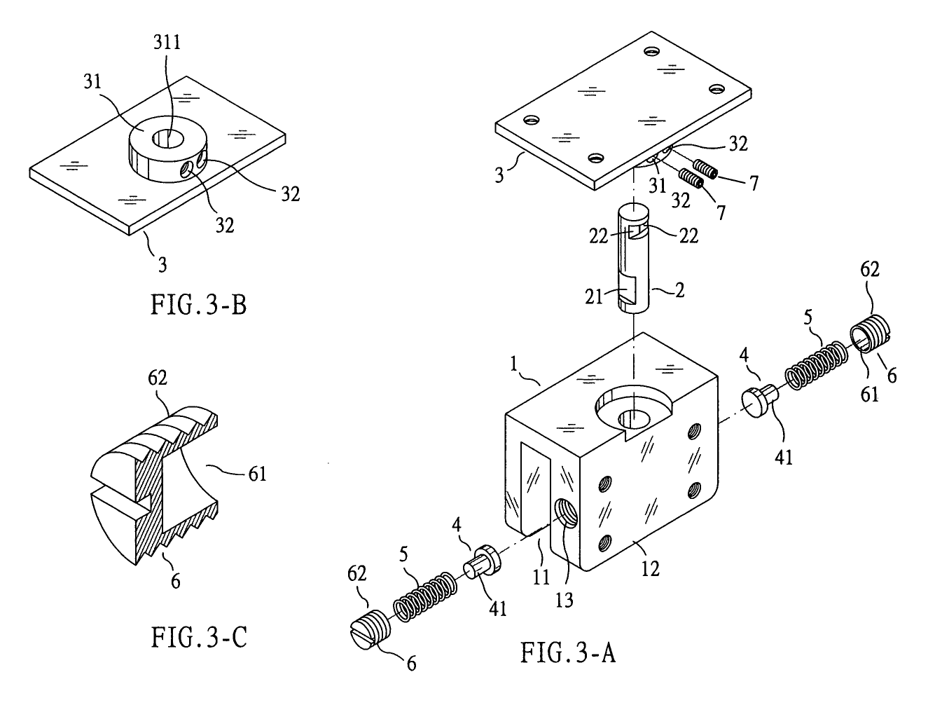

Referring to FIGS. 3A, 3B and 3C for the detailed description of the present invention, a glass door hinge structure comprises a hinge base 1, an axial bolt 2, and a fixing base 3. The hinge base 1 has a clamping groove 11 at its middle and one of the surface of the hinge base 1 is a thickened surface 12, and the thickened surface 12 has a transversal screw hole 13 for installing and combining a protruding bolt 4, a long spring coil 5, and a rotating screw bolt 6, wherein both ends of the long spring coil 5 are clamped and coupled to a protruding center 41 of the protruding bolt 4 and an indent 61 of the rotating screw bolt 6, and an external screw thread 62 at the external surface of the rotating screw bolt 6 is screwed and connected to a transversal screw hole 13 in the hinge base 1 for adjusting the resilience of the long spring coil 5, and the screw hole 13 at its center position has a vertical internal hole for installing the axial bolt 2, and a sunken groove 21 is disposed on both upper sides of the axial bolt 2 for propping the protruding bolt 4 by the resilience of the long spring coil 5, and the bottom of the axial bolt 2 is fixed into a center hole 311 of a hole base 31 in the fixing base 3 that is situated and fixed to the ground, and the two long screw bolts 7 are screwed into long screw thread holes 32 of the hole base 31 in the fixing base 3 and in contact with two sunken surfaces 22 disposed on both left and right sides of the axial bolt 2.

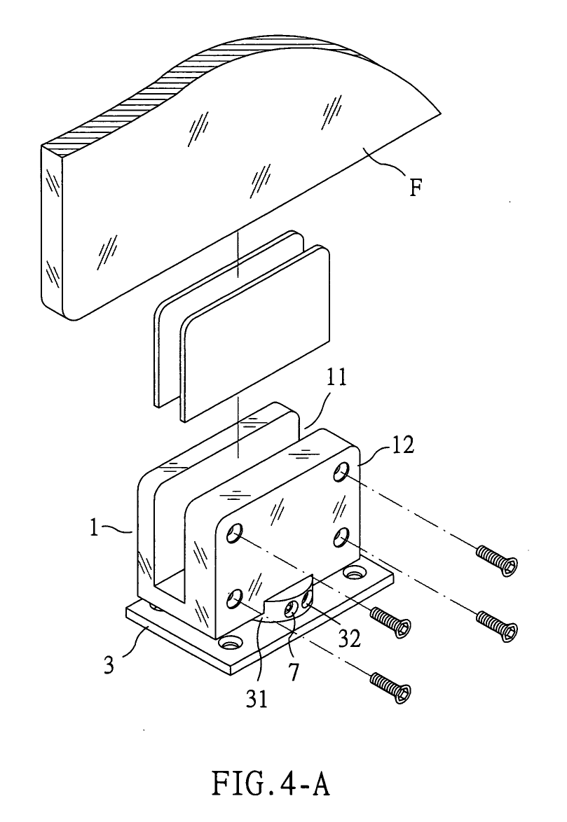

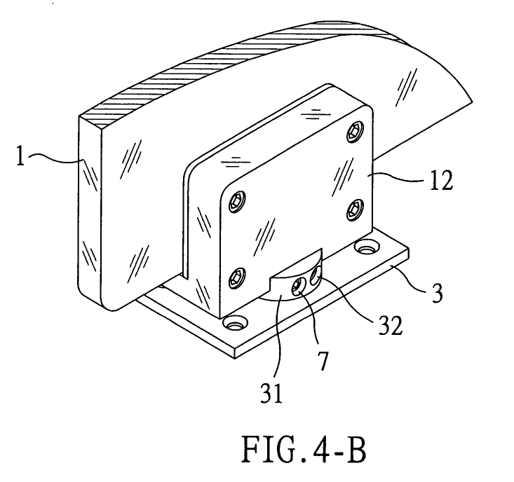

If the two glass doors F are installed at the positions in the clamping groove 11 at the middle of the hinge base 1 (as shown in FIGS. 4A and 4B), the glass door F can be installed directly since it is not necessary to make any cutting on the glass door F, and thus the invention can overcome the shortcomings of the prior art that requires cutting gaps on the glass door F or damages the glass door F or increases the cost.

The two long screw bolts 7 are turned and fixed into the long screw thread holes 32 adjacent to the hole base 31 of the fixing base 3 on the ground, so as to push and press the axial bolt 2 or turn the axial bolt 2 outward (as shown in FIG. 6). As a result, the pressed axial bolt 3 is turned to change its angle and drive both edges of the glass door F to turn slightly, so as to adjust both edges of the glass door F linearly. Before the two long screw bolts 7 are in contact with the two sunken surfaces 22 on both lower left and right sides of the axial bolt 2, the two long screw bolts 7 are passed through the long screw thread holes 32 of the hole base 31 of the fixing base 3, and thus enhancing the screw connection of the long screw bolts 7.

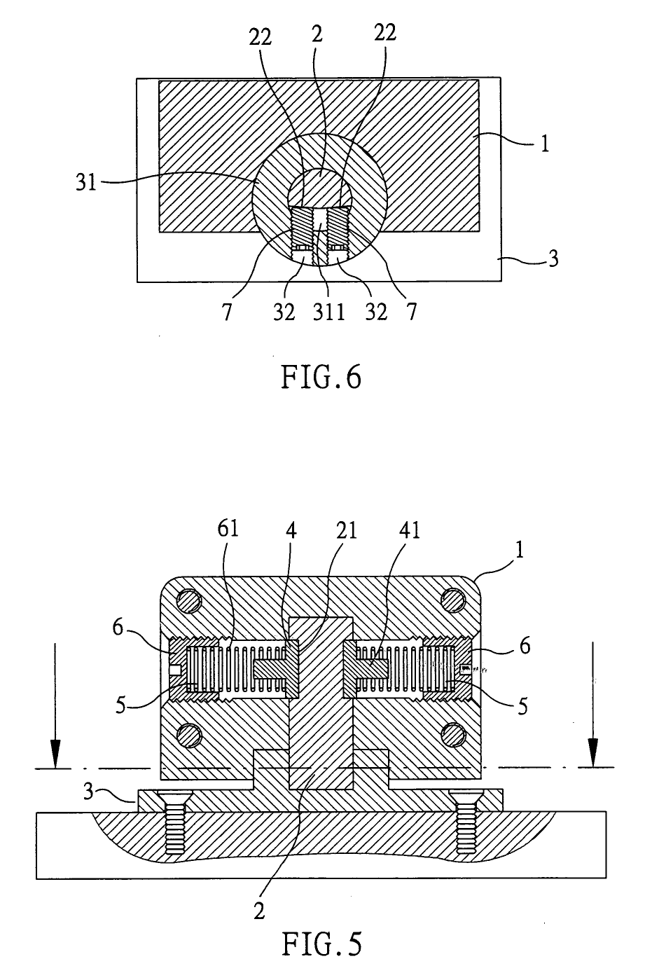

Since the length of the long spring coil 5 installed to both sides of a transversal screw hole 13 of the hinge base 1 is increased by the protruding bolt 4 and the rotating screw bolt 6 on both sides of the long spring coil 5, its length is longer than that of a traditional long spring coil 5 (as shown in FIG. 5), and thus enhancing the resilience and achieving the effect of resuming the two glass doors F quickly to their closed position.

In summation of the above description, the present invention definitely achieves the expected objective and provides an improved structure to enhance the performance over the prior art. The invention further complies with the patent application requirements and is duly filed for the patent application.

What is claimed is:

1. A glass door hinge structure, comprising a hinge base, an axial bolt, and a fixing base, and two sunken surfaces disposed on both lower left and right sides of said axial bolt are situated into a center hole of a hole base in said fixing base that is fixed to the ground, and said sunken grooves disposed on both lateral sides of the axial bolt are provided for propping a protruding bolt by the resilience of a long spring coil; characterized in that said hinge base has a clamping groove at the middle of said hinge base, and one of the surfaces of said base is a thickened surface, and said thickened surface has a transversal screw hole for installing and combining a protruding bolt, a long spring coil, and a rotating screw bolt, wherein both ends of said long spring coil are clamped and coupled by a protruding center of said protruding bolt and an indent of said rotating screw bolt for increasing the length and the resilience of said long spring coil; and the middle of said screw hole has as vertical internal hole for installing an axial bolt, and two long screw bolts are screwed into a long screw thread hole of a hole base of said fixing base of contacting the bottom of said axial bolt, such that a glass door is free of gaps and can be installed at a position of said clamping groove in the middle of said hinge base, and the angle of a long screw bolt of said fixing base fixed onto the ground can be adjusted to level both edges of said glass door, and prevent a damage to the screw connection, and said glass door can quickly resume its closed position by means of the resilience of said long spring coil disposed on both sides of said axial bolt.
